(19) United States
(12) Patent Application Publication
(10) Pub. No.: US 2026/0346483 A1
(43) Pub. Date: Nov. 5, 2026

(54) Sealing Device for a Joint of an Industrial Robot

(71) Applicant: ABB Schweiz AG, Baden (CH)

(72) Inventor: Xinguo Fu, Shanghai (CN)

(21) Appl. No.: 19/704,513

(22) Filed: Jun. 11, 2026

Related U.S. Application Data
(63) Continuation of application No. PCT/CN2024/070621, filed on Jan. 4, 2024.

(51) Int. Cl. B25J 19/00; F16J 15/3232

(52) U.S. Cl. CPC B25J 19/0075; F16J 15/3232

(57) ABSTRACT

A sealing device for a joint of an industrial robot and an industrial robot. The sealing device includes a ring body, the ring body including a circumferential section arranged to circumferentially surround portions of first and second joint parts of the industrial robot, and configured to form a first seal contact with an outer circumferential surface of the first joint part and to form a second seal contact with an outer circumferential surface of the second joint part, the first joint part being rotatable around a rotation axis with respect to the second joint part; and a radial section extending radially and inwardly from the circumferential section and fitted within a clearance formed by the first joint part and the second joint part.

### TECHNICAL FIELD

Embodiments of the present disclosure generally relate to a robotic joint, in particular, a sealing device for sealing a robotic joint.

### BACKGROUND

Industrial robots are widely used in various industries. An industrial robot typically includes a manipulator having a plurality of robotic arms. Each robotic arm may include a first arm body, a second arm body movable with respect to the second arm body, and an actuator for moving the second arm body. A combination of the first arm body, the second arm body and the actuator is typically called a joint. In many applications, such as food industrial, pharmaceutical industry and the like, there is a high hygiene requirement, and the industrial robot should be operated in a “clean room” environment. Accordingly, there is a need to seal an interface between the first arm body and the movable second arm body to prevent any inner components within the arm bodies of the industrial robot from being exposed to the environment. Conventional joint sealing devices are not satisfactory. There is a need to improve the conventional joint sealing device.

### SUMMARY

Example embodiments of the present disclosure provide a sealing device for a joint of an industrial robot and an industrial robot comprising the same which can improve sealing performances with reduced costs.

In a first aspect of the present disclosure, there is provided a sealing device for a joint of an industrial robot. The sealing device comprises a ring body comprising a circumferential section arranged to circumferentially surround portions of first and second joint parts of the industrial robot, and configured to form a first seal contact with an outer circumferential surface of the first joint part and to form a second seal contact with an outer circumferential surface of the second joint part, the first joint part being rotatable around a rotation axis with respect to the second joint part; and a radial section extending radially and inwardly from the circumferential section and fitted within a clearance formed by the first joint part and the second joint part.

According to the present disclosure, the sealing device circumferentially surrounds the first and second joint parts and is configured to seal the joint outside the circumferential surface of the joint parts. The sealing device is not sensitive to the dimension tolerances of the first and second joint part, which means reduced manufacturing costs. Since the contact surface for sealing is formed at inner circumferential surface, it is easy to get a high-quality sealing surface which improves the sealing performance with reduced costs. Moreover, it is easy to assembly the sealing device onto the joint via axial movement of the sealing device.

In some embodiments, the circumferential section may comprise: a base comprising a first end and a second end opposite to the first end, and a first leg extending from the base at the first end and comprising a first sealing lip configured to abut the outer circumferential surface of the first joint part; and a second leg extending from the base at the second end and comprising a second sealing lip configured to abut the outer circumferential surface of the second joint part. With this arrangement, the circumferential section is of simplified shape and is easy to manufacture in a cost-effective way.

In some embodiments, at least one of the first and second legs may comprise a bent portion extending axially toward the radial section to define a receiving space in the leg. With this arrangement, the bent portion may further increase a strength at the sealing lip.

In some embodiments, the sealing device may further comprise at least a spring arranged within the receiving space and configured to apply a radial biasing force to the sealing lip. With this arrangement, the sealing lip can be maintained good sealing performances even working over a long time.

In some embodiments, the ring body may be an integral body, and at least one of the first and second seal contacts may be a linear contact.

In some embodiments, the radial section may comprise at least one radial leg extending radially and inwardly from the circumferential section, and the at least one radial leg is configured to at least partially contact the first joint part to axially position the ring body with respect to the first joint part. With this arrangement, the sealing device can be manufactured in a cost-effective way, for example, by injection molding.

In some embodiments, the at least one radial leg may comprise an axial flared portion configured to contact a mating surface of the first joint part. With the axial flared potion, the sealing device can be reliably clamped between the first and second joints.

In some embodiments, a base portion of the axial flared portion may have a reduced thickness compared to a distal end of the axial flared portion.

In some embodiments, the at least one radial leg may be shaped to form, along with a portion of the circumferential section, a receiving space on a side adjacent to the first joint part, the receiving space being configured to receive a flange of the first joint part.

In some embodiments, the first seal contact may be a surface contact.

In some embodiments, the at least one radial leg may be spaced from the second joint part by a gap. With this arrangement, friction of the radial leg can be reduced.

In a second aspect of the present disclosure, there is provided a joint for an industrial robot. The joint comprises a first joint part comprising a first housing that defines a cavity; an actuator comprising a fixed part and a movable part rotatable around a rotation axis with respect to the fixed part, the fixed part being fixed to the first housing within the cavity; a second joint part comprising a second housing and axially fixed to the movable part of the actuator; and a sealing device according to any of the first aspect configured to seal a clearance formed by the first housing and the second housing.

In some embodiments, circumferential edges of the first joint part and the second joint part at a side adjacent to the sealing device may be chamfered to allow axial movement of the sealing device onto the respective outer circumferential surface of the first and second joint part.

In a third aspect of the present disclosure, there is provided an industrial robot. The industrial robot comprises a manipulator, wherein the manipulator comprises at least one joint according to any of the second aspect.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a perspective view of an industrial robot according to one example embodiment of the present disclosure;

FIG. 2 is a joint including the sealing device according to a first example embodiment of the present disclosure, with an actuator arranged within the joint;

FIG. 3 is a partial enlarged view of the joint including the sealing device shown in FIG. 2;

FIG. 4 is a joint including the sealing device according to a second example embodiment of the present disclosure;

FIG. 5 is a partial enlarged view of the joint including the sealing device shown in FIG. 4; and

FIG. 6 is a joint including the sealing device according to a third example embodiment of the present disclosure.

Throughout the drawings, the same or similar reference symbols are used to indicate the same or similar elements.

### DETAILED DESCRIPTION

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

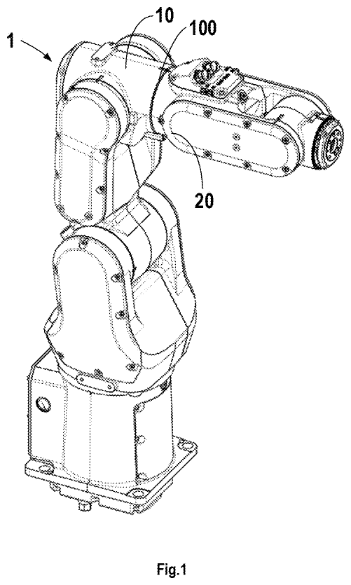

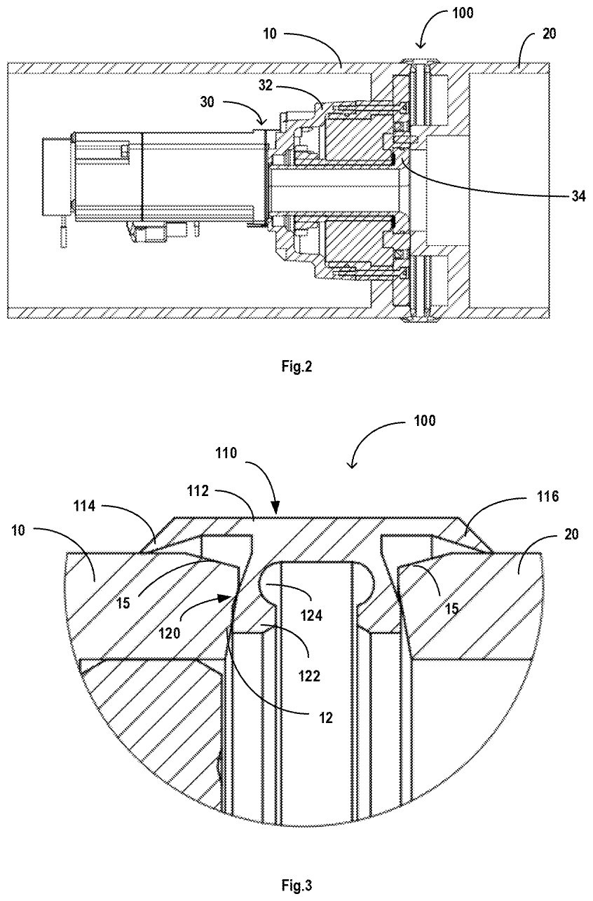

FIG. 1 is a perspective view of an industrial robot 1 according to one example embodiment of the present disclosure. FIG. 2 is a joint including the sealing device according to a first example embodiment of the present disclosure, with an actuator arranged within the joint. As shown in FIG. 1, the industrial robot 1 includes a manipulator which includes a plurality of joints. An end flange for receiving a tool may be provided at the distal end of the manipulator. During the operation of the industrial robot, the plurality of joints is controlled so as to cause manipulator and the tool to move in a workspace of the industrial robot to perform various tasks.

Each joint may include a first joint part 10 (also called arm body) and a rotatable second joint part 20 adjacent to the first joint part 10. The second joint part 20 is configured to move around a rotation axis with respect to the second joint part 20. An actuator, such as a motor as well as a gear box connected to the motor, may be arranged on the joint part 10, 20 to cause the second joint part 20 to rotate with respect to the first joint part. The first joint part 10 may include a housing defining a cavity. The second joint part 20 may also include a housing defining a cavity. Various components, including actuators, wirings for powering the actuators, cables for communication, various sensors, and the like may be arranged within the cavity.

There is a clearance between the first joint part 10 and the rotatable second joint part 20. As shown in FIG. 2, the actuator 30 may include a fixed part 32, such as a stator of the motor, and a movable part 34, such as a rotor of the motor. The fixed part 32 of the actuator 30 is fixed to the first joint part 10 via screws. The movable part 34 of the actuator 30 is fixed to the second joint part 20 via screws. During the assembly process, a sealing device is required to seal the clearance between the first joint part 10 and the rotatable second joint part 20 during the assembly of the industrial robot.

In one sealing device, the sealing device includes a pair of sealing interfaces which are axially provided. The sealing interfaces axially abut an axial end surfaces of the joint part 10, 20. This kind of sealing device is subject to the following drawbacks. Due to the fact that a size of the clearance between the axial end surface of the first joint part 10 and the axial end surface of the second joint part 20 varies in accordance with the manufacturing tolerance. It is costly to precisely process the first joint part 10 and the second joint part 20 to ensure a uniform clearance between the axial end surface of the first joint part 10 and the axial end surface of the second joint part 20 such that the sealing interfaces of the sealing device can precisely mate the axial end surfaces of the arm bodies 10, 20, which means high manufacturing costs. A taper may be provided in the sealing interfaces of the sealing device. The taper may create wedging effect to improve sealing performances. However, provision of taper means that the sealing interfaces include sharp edges throughout the whole circumference. Any little defect on the sharp edge may deteriorate the sealing performances of the sealing device. Another problem as for provision of taper is that the taper is difficult to get a high-quality sealing surface since plunge-cut grinding cannot be applied on the sealing surface, which further deteriorates sealing performances of the sealing device.

According to the present disclosure, a novel sealing device is provided which obviates one or more drawbacks mentioned above. The sealing device according to the present disclosure, the sealing device including circumferential sealing interfaces rather than axial sealing interfaces.

FIG. 2 shows a joint including the sealing device according to a first example embodiment of the present disclosure and FIG. 3 is a partial enlarged view of the joint shown in FIG. 2. As shown in FIGS. 2 and 3, the sealing device comprises a ring body 100. The ring body 100 may be integrally formed, for example, via injection molding. In some embodiments, the ring body 100 may be made of PTFE and other similar plastic material.

The ring body 100 includes a circumferential section 110 and a radial section 120 extending radially and inwardly from the circumferential section 110. The circumferential section 110 is arranged radially outside a first joint part 10 and a second joint part 20 of the industrial robot. The circumferential section 110 is configured to form a first seal contact with an outer circumferential surface of a portion of the first joint part 10 and to form a second seal contact with an outer circumferential surface of a portion of the second joint part 20. The radial section 120 is fitted with in a clearance formed by the first joint part 10 and the second joint part 20. Thus, the sealing interfaces between the sealing device and the first joint part 10 and a second joint part 20 are on the circumferential side. With this arrangement, the sealing performance is not sensitive to the size of the clearance between the axial end surfaces of the first joint part 10 and the axial end surfaces of the second joint part 20. Also, it is easy to get a high-quality sealing surface with reduced costs, for example, by grinding the contact surfaces of the circumferential section 110.

In some embodiments, as shown in FIGS. 2 and 3, the circumferential section 110 may include a base 112, a first leg 114, and a second leg 116. The base 112 may include a first axial end and a second axial end opposite the first end. The first leg 114 may radially extend from the base 112 at the first end. The first leg 114 may include a first sealing lip which is configured to abut the outer circumferential surface of the portion of the first joint part 10. Thus, a first sealing interface is formed between the first sealing lip and the outer circumferential surface of first joint part 10. Likewise, the second leg 116 radially extends from the base 112 at the second end. The second leg 116 may include a second sealing lip configured to abut the outer circumferential surface of the portion of the second joint part 20. Thus, a first sealing interface is formed between the first sealing lip and the outer circumferential surface of first joint part 10. In the example shown, the second leg 116 is of the same configuration as the first leg 114. It is to be understood that the example shown is merely illustrative and the second leg 116 may be of different configuration from the first leg 114.

In some embodiments, the first leg 114 may be shaped to be flared toward the outer circumferential surface of first joint part 10. This may be advantageous for ensuring reliable contact between the first leg 114 and the outer circumferential surface of first joint part 10. In some embodiments, the first leg 114 may form a linear contact at the sealing interface. It is to be understood that the example shown is merely illustrative and the first leg 114 may form a surface contact at the sealing interface.

In some embodiments, as shown in FIG. 3, a chamfered portion 15 may be formed at outer circumferential surface of first joint part 10. This may facilitate assembling the first leg 114 of the sealing device 100 onto the outer circumferential surface of the first joint part 10. In particular, when the first joint part 10 is in position, the sealing device 100 may be axially moved toward the first joint part 10. Provision of the chamfered portion 15, it facilitates pushing the first leg 114 of the sealing device 100 onto the outer circumferential surface of the first joint part 10. After the sealing device 100 is placed in position, the second joint part 20 may be axially moved to get closer to the first joint part 10 and then is fixed to the first joint part 10. In some embodiments, as shown in FIG. 3, as seen in the axial cross section of the sealing device 100, an edge corner of the base 112 may be rounded or chamfered. This may be advantageous in facilitating sealing.

In some embodiments, as shown in FIG. 3, the radial section 120 may include one or more radial legs 122. The radial leg 122 extends inwardly from the circumferential section 110. In the example shown, the radial section 120 includes two radial legs 122 of substantially the same configuration. The left one radial leg 122 is configured to at least partially contact an axial end surface of the first joint part 10 to axially position the ring body 100 with respect to the first joint part 10. This may facilitate fixture of the ring body. The right one radial leg 122 may contact or does not contact an axial end surface of the second joint part 20. It is to be understood that the example shown is merely illustrative of the radial section 120 including one radial leg 122.

In some embodiments, as shown in FIG. 3, the radial leg 122 comprises an axial flared portion which is configured to contact a mating axial end surface 12 of the first joint part 10. Due to the flared potion, the flared potion will provide a pressure on mating axial end surface of the first joint part 10. This may facilitate to firmly keep the sealing lips of the sealing device onto the joint ring surface even if the sealing lips become worn after a long service time. In some embodiments, at least part of the mating axial end surface of the first joint part 10 may include a slope plane to cooperate with the flared portion.

In some embodiments, as shown in FIG. 3, a base portion of the axial flared, i.e., the portion adjacent to the base 112 may be thinned. This may further improve clamping of the sealing device 100 within the clearance. As shown in FIG. 3, an actuate receiving space 124 may be formed at a side far away from the axial end surface 12 of the first joint part 10. It is to be understood that the receiving space may be formed as other proper shapes.

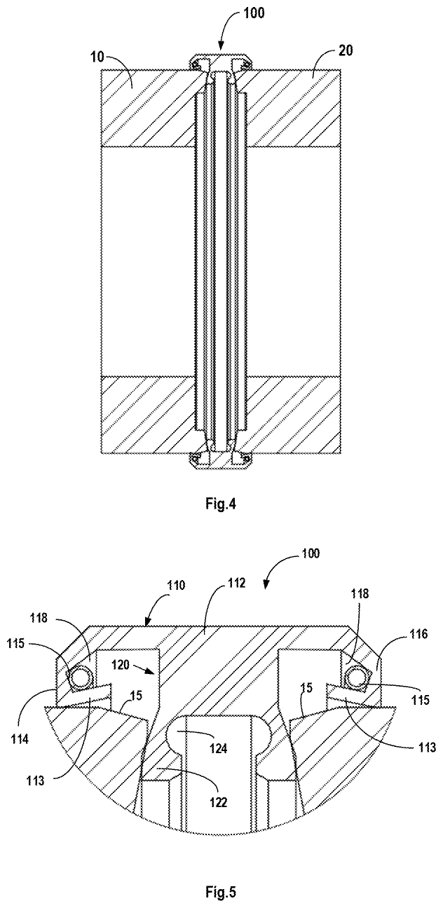

FIGS. 4 and 5 show a joint including the sealing device according to a second example embodiment of the present disclosure. The sealing device shown in FIGS. 4 and 5 are analogous to that shown in FIGS. 2 and 3. Emphasis is placed on describing the different parts and description of the analogous part is omitted.

As shown in FIGS. 4 and 5, the ring body 100 includes a circumferential section 110 and a radial section 120 extending radially and inwardly from the circumferential section 110. The circumferential section 110 is arranged radially outside a first joint part 10 and a second joint part 20 of the industrial robot. The circumferential section 110 is configured to form a first seal contact with an outer circumferential surface of a portion of the first joint part 10 and to form a second seal contact with an outer circumferential surface of a portion of the second joint part 20. The radial section 120 is fitted with in a clearance formed by the first joint part 10 and the second joint part 20.

As shown in FIGS. 4 and 5, the circumferential section 110 may include a base 112, a first leg 114, and a second leg 116. The first leg 114 may include a first sealing lip which is configured to abut the outer circumferential surface of the portion of the first joint part 10. Likewise, the second leg 116 radially extends from the base 112 at the second end. The second leg 116 may include a second sealing lip configured to abut the outer circumferential surface of the portion of the second joint part 20.

As shown in FIGS. 4 and 5, the first and second legs 114, 116 may comprise a bent portion 113 which extends axially toward the radial section 120 to define a receiving space 118 in the leg. Due to the arrangement of the receiving space, the anti-wearing performances at the sealing lip can be improved. In the example shown, both the first and second legs 114, 116 are provided with the receiving space 118. In other example, only one leg of the first legs 114, 116 is provided with the receiving space 118. In some embodiments, a spring 115 may be arranged within the receiving space 118. The spring 115 is configured to apply a radial biasing force to the sealing lip. With this arrangement, the sealing performances can be further improved. In some embodiments, the bent portion 113 is sized such that a gap is formed between a distal end of the leg and the radial section 120 to allow passage of the spring.

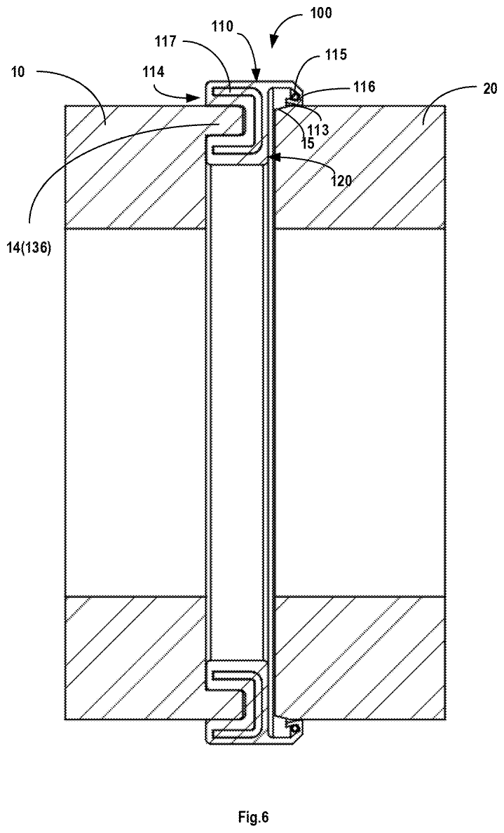

FIG. 6 is a joint including the sealing device according to a third example embodiment of the present disclosure. As shown in FIG. 6, the ring body 100 includes a circumferential section 110 and a radial section 120 extending radially and inwardly from the circumferential section 110. The circumferential section 110 is arranged radially outside a first joint part 10 and a second joint part 20 of the industrial robot. The circumferential section 110 is configured to form a first seal contact with an outer circumferential surface of a portion of the first joint part 10 and to form a second seal contact with an outer circumferential surface of a portion of the second joint part 20. The radial section 120 is fitted with in a clearance formed by the first joint part 10 and the second joint part 20.

As shown in FIG. 6, the first leg 114 may include a first sealing lip which is configured to abut the outer circumferential surface of the portion of the first joint part 10. In the shown example, as shown in the cross-section of the sealing device, a portion of the circumferential section 110 for forming the first seal contact comprises a flat surface as seen in an axial section of the ring body 100. The first sealing lip forms a surface contact with the outer circumferential surface of the portion of the first joint part 10. The second leg 116 is formed as a different configuration from the first leg 114. The second leg 116 may include a second sealing lip configured to abut the outer circumferential surface of the portion of the second joint part 20. In the example shown, as seen in the cross section of the sealing device, the second sealing lip forms a liner contact with the outer circumferential surface of the portion of the second joint part 20. As shown in FIG. 6, the second leg 116 may comprise a bent portion 113 which extends axially toward the radial section 120 to define a receiving space in the leg. A spring 115 may be arranged in the receiving space to apply biasing force to the outer circumferential surface of the portion of the second joint part 20.

In some embodiments, as shown in FIG. 6, there is only one the radial leg 122. The radial leg 122 is shaped to form a circumferential receiving space 136 on a side adjacent to the first joint part 10. The receiving space 136 may be used to receive a flange 14 of the first joint part 10. The flange 14 may be circumferentially provided on axial end surface of the first joint part 10. In the example shown, the radial leg 122 may be of a substantially L-shape as seen in an axial section of the ring body 100. It is to be understood that the radial leg 122 may be of any other proper shape. With this arrangement, the sealing device 100 can be firmly held by the shape fit. In some embodiments, wherein the radial leg 122 may be spaced from the second joint part 20 by a gap. In this way, the friction between the axial end surface of the second joint part 20 and the radial leg 122 can be reduced.

In some embodiments, as shown in FIG. 6, a reinforcement remember 117 may be arranged in the sealing device 100. The reinforcement remember 117 may be made of different material from the ring body, for example, steel. The reinforcement remember 117 may be integrally formed with the ring body by inserting molding.

According to the present disclosure, the sealing device is configured to seal the joint outside the circumferential surface of the joint parts. The sealing device is not sensitive to the dimension tolerances of the first and second joint part, which means reduced manufacturing costs. Since the contact surface for sealing is formed at inner circumferential surface, it is easy to get a high-quality sealing surface, for example, by grinding process, which improves the sealing performances with reduced costs. Moreover, it is easy to assembly the sealing device onto the joint via axial movement of the sealing device.

The description of the various embodiments of the present invention has been presented for purposes of illustration but is not intended to be exhaustive or limited to the embodiments disclosed. Many modifications and variations will be apparent to those of ordinary skill in the art without departing from the scope and spirit of the embodiments described. The terminology used herein was chosen to best explain the principles of the embodiments, the practical application or technical improvement over technologies found in the marketplace, or to enable others of ordinary skill in the art to understand the embodiments disclosed herein.

1. A sealing device for a joint of an industrial robot, comprising a ring body, the ring body including:
a circumferential section arranged to circumferentially surround portions of first and second joint parts of the industrial robot, and configured to form a first seal contact with an outer circumferential surface of the first joint part and to form a second seal contact with an outer circumferential surface of the second joint part, the first joint part being rotatable around a rotation axis with respect to the second joint part; and
a radial section extending radially and inwardly from the circumferential section and fitted within a clearance formed by the first joint part and the second joint part.

2. The sealing device of claim 1, wherein the circumferential section comprises:
a base comprising a first end and a second end opposite to the first end, and
a first leg extending from the base at the first end and including a first sealing lip configured to abut the outer circumferential surface of the first joint part; and
a second leg extending from the base at the second end and including a second sealing lip configured to abut the outer circumferential surface of the second joint part.

3. The sealing device of claim 2, wherein at least one of the first and second legs comprises a bent portion extending axially toward the radial section to define a receiving space in the leg.

4. The sealing device of claim 3, further comprising at least a spring arranged within the receiving space and configured to apply a radial biasing force to the sealing lip.

5. The sealing device of claim 2, wherein the ring body is an integral body, and at least one of the first and second seal contacts is a linear contact.

6. The sealing device of claim 1, wherein the radial section comprises at least one radial leg extending radially and inwardly from the circumferential section, and the at least one radial leg is configured to at least partially contact the first joint part to axially position the ring body with respect to the first joint part.

7. The sealing device of claim 6, wherein the at least one radial leg comprises an axial flared portion configured to contact a mating surface of the first joint part.

8. The sealing device of claim 7, wherein a base portion of the axial flared portion has a reduced thickness compared to a distal end of the axial flared portion.

9. The sealing device of claim 6, wherein the at least one radial leg is shaped to form, along with a portion of the circumferential section, a receiving space on a side adjacent to the first joint part, the receiving space being configured to receive a flange of the first joint part.

10. The sealing device of claim 6, wherein the first seal contact is a surface contact.

11. The sealing device of claim 6, wherein the at least one radial leg is spaced from the second joint part by a gap.

12. A joint for an industrial robot, comprising:
a first joint part comprising a first housing that defines a cavity;
an actuator comprising a fixed part and a movable part rotatable around a rotation axis with respect to the fixed part, the fixed part being fixed to the first housing within the cavity;
a second joint part including a second housing and axially fixed to the movable part of the actuator; and
a sealing device, including a ring body, the ring body includes:
a circumferential section arranged to circumferentially surround portions of first and second joint parts of the industrial robot, and configured to form a first seal contact with an outer circumferential surface of the first joint part and to form a second seal contact with an outer circumferential surface of the second joint part, the first joint part being rotatable around a rotation axis with respect to the second joint part; and
a radial section extending radially and inwardly from the circumferential section and fitted within a clearance formed by the first joint part and the second joint part configured to seal a clearance formed by the first housing and the second housing.

13. The joint of claim 12, wherein circumferential edges of the first joint part and the second joint part at a side adjacent to the sealing device are chamfered to allow axial movement of the sealing device onto the respective outer circumferential surface of the first and second joint part.

14. An industrial robot comprising a manipulator, wherein the manipulator comprises at least one joint, including:
a first joint part comprising a first housing that defines a cavity;
an actuator comprising a fixed part and a movable part rotatable around a rotation axis with respect to the fixed part, the fixed part being fixed to the first housing within the cavity;
a second joint part including a second housing and axially fixed to the movable part of the actuator; and
a sealing device including a ring body, the ring body includes:
a circumferential section arranged to circumferentially surround portions of first and second joint parts of the industrial robot, and configured to form a first seal contact with an outer circumferential surface of the first joint part and to form a second seal contact with an outer circumferential surface of the second joint part, the first joint part being rotatable around a rotation axis with respect to the second joint part; and
a radial section extending radially and inwardly from the circumferential section and fitted within a clearance formed by the first joint part and the second joint part configured to seal a clearance formed by the first housing and the second housing.

15. The sealing device of claim 3, wherein the ring body is an integral body, and at least one of the first and second seal contacts is a linear contact.

16. The sealing device of claim 2, wherein the radial section comprises at least one radial leg extending radially and inwardly from the circumferential section, and the at least one radial leg is configured to at least partially contact the first joint part to axially position the ring body with respect to the first joint part.

17. The sealing device of claim 7, wherein the at least one radial leg is shaped to form, along with a portion of the circumferential section, a receiving space on a side adjacent to the first joint part, the receiving space being configured to receive a flange of the first joint part.

18. The sealing device of claim 7, wherein the first seal contact is a surface contact.

19. The sealing device of claim 7, wherein the at least one radial leg is spaced from the second joint part by a gap.
